(19) United States
(12) Patent Application Publication
(10) Pub. No.: US 2016/0376113 A1
(43) Pub. Date: Dec. 29, 2016

(54) CONVEYING DEVICE

(71) Applicant: LISEC AUSTRIA GMBH, Seìtenstetten (AT)

(72) Inventor: Leopold MADER, Neuhofen/Ybbs (AT)

(21) Appl. No.: 14/903,230

(22) PCT Filed: Jan. 26, 2015
(86) PCT No.: PCT/AT2015/000009

§ 371 Date: Jan. 6, 2016

(30) Foreign Application Priority Data
Jan. 28, 2014 (AT) A 58/2014

(51) Int. Cl. B65G 49/06; E06B 3/673

(52) U.S. Cl. CPC B65G 49/067; E06B 3/67365

(57) ABSTRACT

Disclosed is a device (1) for transporting plate-type objects such as insulating-glass blanks (20), for example from the discharge point (10) of a sealing station into a storage area formed by harp racks (30) and/or bearing blocks (40), the device having a suction field (2) that can be attached to the insulating-glass blank (20). The lower edge of the suction field (2) is provided with supporting fingers (7) which support, from below, the insulating-glass blank (20) that is held by the suction field (2), and the supporting fingers (7) can be pivoted into their active positions independently of one another. Once an insulating-glass blank (20) has been deposited in a harp rack (30) or on a bearing block (40), the supporting fingers (7) are pivoted back into their standby position, such that the suction field (2) can be moved out of the harp rack (30) or the bearing block (40).

The invention relates to a device for conveying plate-like objects, in particular insulating-glass blanks before and after sealing.

During the production of insulating glass, pane packets (“insulating-glass blanks”), comprising at least two glass panes and a spacer (“spacer”) arranged between the latter, are produced. The spacer can consist of a hollow-section strip that is made of metal or plastic or a strand that can be made of thermoplastic or elastoplastic material. In this case, a spacer is put on a glass pane, and a second glass pane is placed on the spacer at an assembly station, so that an insulating-glass blank is formed. Insulating-glass blanks are still not stable, since the edge bond is only finished after the insulating-glass blank has been sealed and the sealing compound has set. Therefore, insulating-glass blanks must be carefully transported in order to keep the glass panes from shifting and optionally to avoid a deformation of the spacer.

It is known, and, during production of insulating glass, it is common to fill with sealing compound (to seal) the edge seam of insulating-glass blanks that is open outward and lying between the glass panes and outside of the spacer in order to achieve the final edge bond of the glass panes of the insulating glass.

For sealing insulating-glass blanks, different proposals relating to method and device have been made.

In particular, it is problematic to transport the insulating-glass blanks during and after sealing since sealing compound, as long as it has not hardened, is very sticky, and transport means, which engage on the (lower) edge of the sealed insulating-glass blanks, become soiled. In order to solve this problem, proposals for special designs of conveying means have been made (cf., e.g., AT 384 596 B, EP 0 122 405 A, EP 0 857 848 A, and DE 34 00 031 C).

It is essential for the handling (transporting, transferring, de-stacking) of insulating-glass blanks before and after sealing that both glass panes be supported so that the packet that forms the insulating-glass blank that consists of at least two glass panes and a spacer is not deformed by moving, e.g., dropping, one of the glass panes or the spacer.

A device for transferring substrates, which can be components of displays, is known from US 2011/0318144 A. In the case of the known device, substrates that are horizontally-oriented, i.e., lying flat, are moved between processing stations using robots. The robots comprise arms that can be pivoted around essentially vertical axes. Holding systems are provided on the robotic arms, which systems have suction heads and also claws in order to hold the substrates.

JP 2003-212340 A relates to a device for transporting and holding insulating glass, whereby a relative movement between the glass panes of insulating glass is to be avoided while the latter is moved essentially vertically upright. The device that is provided for this purpose comprises suction heads supplied with underpressure and a support that engages with expansion bearings on the lower edges of the glass panes of insulating glass.

WO 2010/041492 A relates to a device for handling glass panes, whereby protective films and glass panes are alternately placed over one another in stacks. To transfer glass panes from a storage support to the stacking device, a robot is provided, whose suction field is equipped laterally with stops for attaching glass panes.

WO 2005/105541 A discloses a system for handling glass panes, whereby suction heads are provided on a frame that is equipped with rollers. Expansion bearings for the glass panes that can swing in and out are arranged below the suction heads. The suction heads are provided on slots that are guided back and forth in an adjustable manner over guide rails. The expansion bearings on the lower end of the guide rails are used for the slots to collect a glass pane if the lifting system should fail for the slots.

WO 2013/056288 A shows a unit for sealing insulating-glass blanks, whereby the insulating-glass blanks in the sealing station are clamped from below by grippers and by laterally-engaging suction heads and are not moved. When the insulating-glass blanks are transported into the sealing station, the blanks are moved upright on rollers or conveyor belts.

EP 0 122 405 A shows a unit for sealing insulating-glass blanks, whereby the insulating-glass blanks are to be removed from the sealing station with a removal device. The removal device comprises a frame on which suction heads are provided, whereby the frame can be run between a position behind the sealing station and a removal station. When removing insulating-glass blanks after the sealing using the removal device, the sealed insulating-glass blank is held exclusively by suction heads engaging on one of its glass panes. Support elements that support the insulating-glass blank from below are not provided.

EP 2 460 971 A relates to an automatic sealing device with a conveying system that is divided into two parts, whereby one part is to move the front glass pane and the other part is to move the rear glass pane of the insulating glass. The rear part can be adjusted so that it can be matched to the thickness of the insulating glass and to the progressive glass. The rear part carries support elements; the front part carries support elements. In FIGS. 7 to 10 of EP 2 460 971 A, the situation when unloading sealed insulating glass is shown. In this case, suction devices (cf. paragraph [0044]) are to be moved into the position of FIG. 10 in order to deposit insulating glass on a removal system. The removal system has rigid support links (cf. 6, 8 and 10). Suction heads are not provided on the removal system. If a three-pane insulating glass is waiting to be unloaded, the middle glass pane can be held by retractable support elements (FIG. 15). The support elements shown in FIG. 18 are to be active during sealing. EP 2 460 971 A thus shows a removal system with rigid support elements on the lower edge of a frame. One drawback of this design is that the conveying system has to be lowered when the suction devices transfer the insulating glass, so that the latter is not supported from below.

The object of the invention is to make available a device of the above-mentioned type with which plate-like objects can be handled safely.

This object is achieved according to the invention with a device that has the features of claim 1.

Preferred and advantageous configurations of the invention are subjects of the subclaims.

Since support elements are provided in the device according to the invention, heavy plate-like objects (e.g., glass panels, bullet-proof glass, laminated glass panels) can be handled safely, e.g., transported, transferred, and de-stacked.

In particular, insulating-glass blanks that are sealed with the device according to the invention can be picked up at the end of the outflow segment of a sealing device and can be deposited on storage racks or storage supports. This is also when the sealing compound that produces the edge bond of insulating glass is still fresh, i.e., not solidified.

The device according to the invention also makes it possible to transport pane packets assembled to form insulating-glass blanks safely and easily from an assembly station (optionally after the inside space of the insulating-glass blank is filled with a gas that is different from air) to a sealing station.

This is the case even when spacers made from a thermoplastic material are used for the insulating glass that is to be produced.

Since, in the device according to the invention, support elements are provided in the lower area of the suction field, which elements rest in their active positions from below on the lower edge of the object, e.g., of the insulating-glass blank, the object is held securely, and the risk no longer exists that the object, in particular the glass pane or the glass panes of the insulating-glass blank, on which the suction devices of the suction field do not engage, may drop.

In particular, consideration is given to providing the device according to the invention in connection to the outflow from a sealing station, which is designed, for example, as is known from AT 384 596 B.

Since the support elements, provided below the suction field in the case of the device according to the invention, can be moved, in particular pivoted, in and out of their active positions, the suction field can be arranged in the area of the end of the outflow from the sealing station. After the suction devices have acquired the sealed insulating-glass blank, the sealed insulating-glass blank can be kept moving and moved away from the outflow from the sealing station. In this case, it is provided that the support elements, which are arranged on the lower edge of the suction field, are moved little by little into their active positions (pivoted), so that they support the area of the insulating-glass blank moving out over the outflow from the sealing station. In this case, it is provided, for example, that the support elements, which are located just outside, i.e., next to the outflow from the sealing station, are moved into their active positions, supporting the object, e.g., an insulating-glass blank.

In particular, the support elements support the glass pane of an insulating-glass blank, on which the suction devices of the suction field of the device according to the invention do not engage.

The device according to the invention makes it possible to deposit sealed insulating-glass blanks in storage supports or compartment racks.

Preferred are compartment racks, in combination with the device according to the invention, racks whose compartments are formed by rods that are not connected to one another on their upper ends.

Alternatively, consideration is given to using storage supports together with the device according to the invention, supports on which stops are provided and stops on which sealed insulating-glass blanks are placed. In addition, holding fingers are provided, which are affixed to the outside of the glass panes of insulating-glass blanks and thus hold the insulating-glass blank on the storage support in an essentially vertical position.

The device according to the invention also makes it possible to rework the sealing compound of an insulating-glass blank in the area of its corners, after it has left the outflow from the sealing station, if this is necessary.

The described design of compartment racks, on the one hand, and storage supports, on the other hand, makes it possible that sealed insulating-glass blanks can be easily set in compartment racks or deposited on storage supports using the device according to the invention, even before the sealing compound has solidified.

In any case, with the device according to the invention, the stability of the insulating-glass blanks is secured both during their transport before and after the sealing and after they have been deposited in a compartment rack or storage support after the sealing.

Since the support elements on the lower edge of the suction field can be switched into their and out of their active positions, the latter can be moved away after a sealed insulating-glass blank is set in a compartment rack or after it is deposited on a storage support from their active positions, in which they engage from below the lower edge of the sealed insulating-glass blank, so that the suction field can be easily moved out upward from the compartment rack or the storage support.

With the invention, the problem is also solved that the sealing compound that is used for insulating-glass blanks requires some time (a few hours) for solidifying (hardening). During this time, the edge bond of the insulating-glass blank is still not finished, so that the risk exists that the packet of spacer and glass panes that forms the insulating-glass blank may become deformed. This risk is avoided when using the device according to the invention, since the sealed insulating-glass blank is securely supported when being removed from the sealing station until being deposited on a storage support or in a compartment rack from below by support elements (for example, support fingers).

With the device according to the invention, the advantage results that the weight of the at least one pane that is not held by suction devices does not burden the edge bond of an insulating-glass blank—specifically before sealing, right after sealing, during the reworking of the sealing (manual or automatic reworking of corners) and also during subsequent storage, i.e., during any manipulation that takes place before the introduction of sealing compound and before the hardening of the sealing compound of the edge bond.

The device according to the invention also has the advantage that deformation of in particular thermoplastic spacers, which tend to creep immediately after application, can be prevented.

Further details and features of the invention follow from the description below of a preferred embodiment of a conveying device in the example of its use after a sealing station and of compartment racks or storage supports that can be used within the scope of the invention. Here:

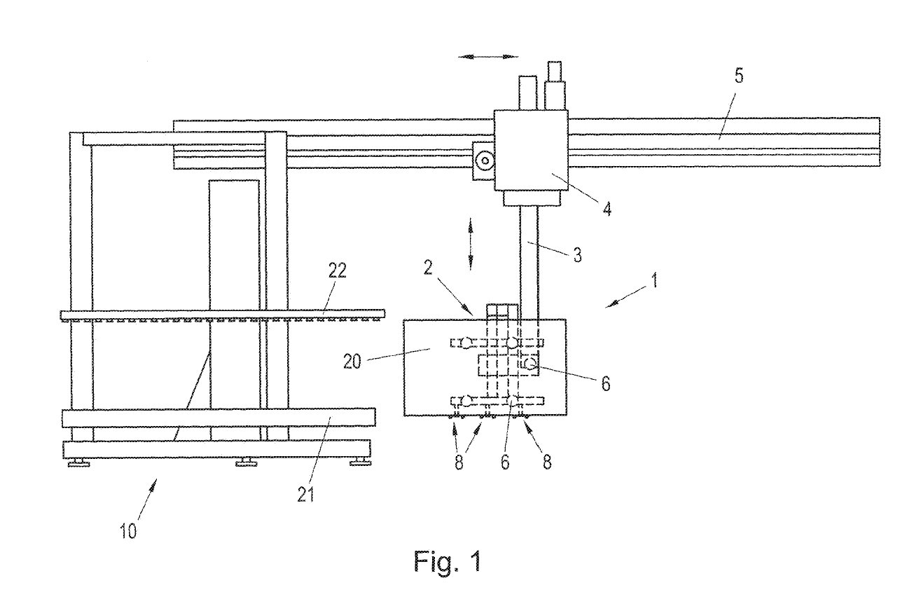

FIG. 1 shows in a view a device that is assigned to the outflow from a sealing station,

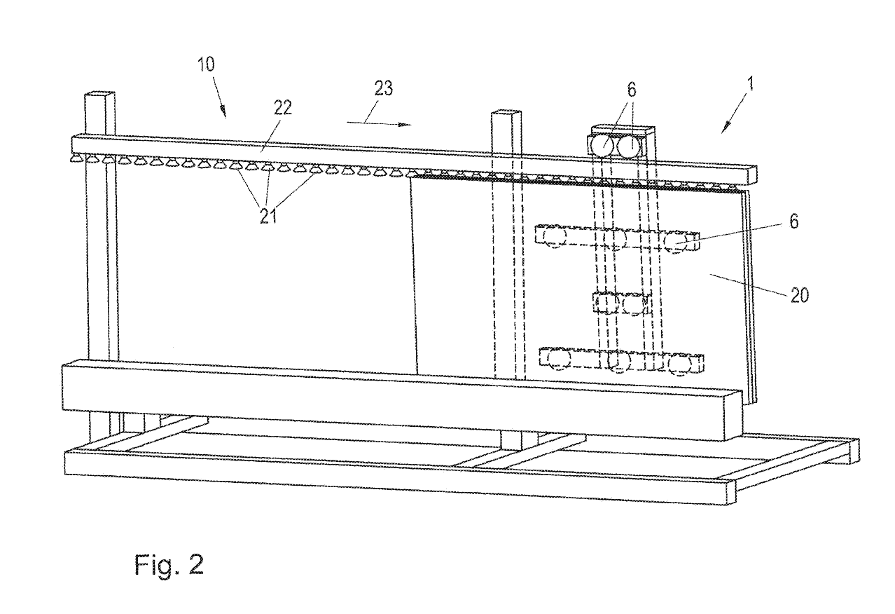

FIG. 2 shows a sealed insulating-glass blank at the end of the outflow with a positioned device,

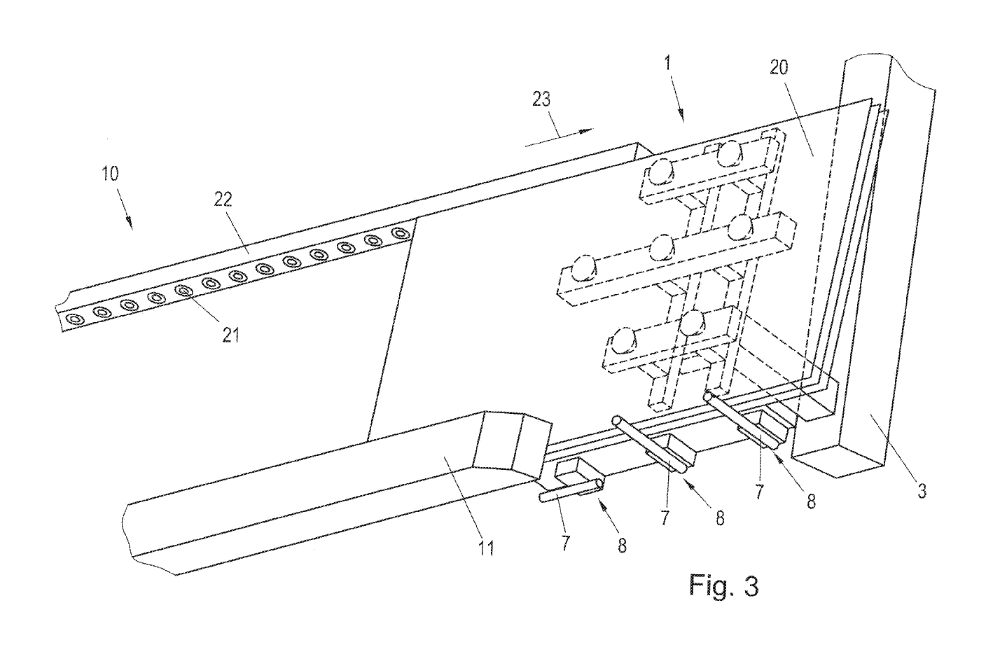

FIG. 3 shows the picking up of an insulating-glass blank by the device according to the invention,

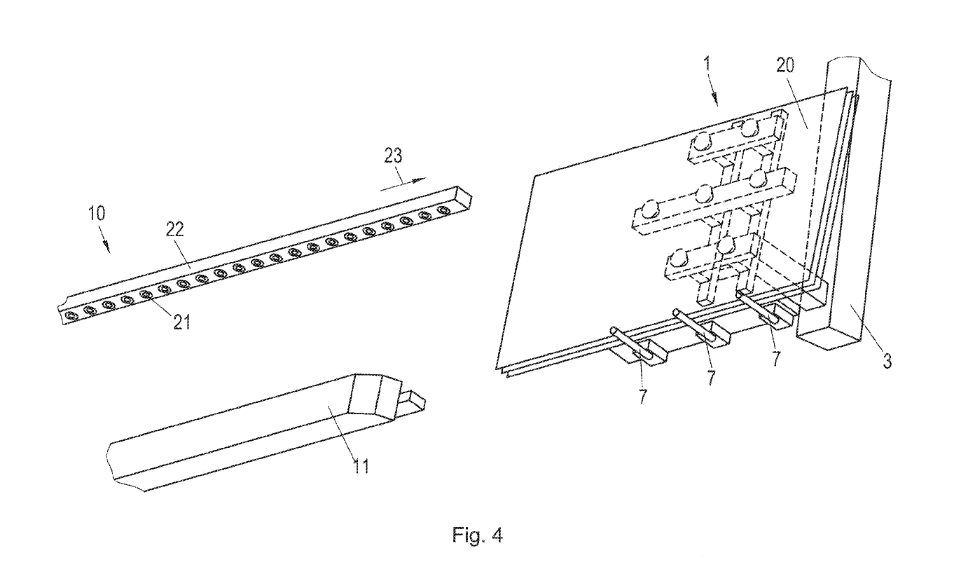

FIG. 4 shows an insulating-glass blank that is held by a device according to the invention,

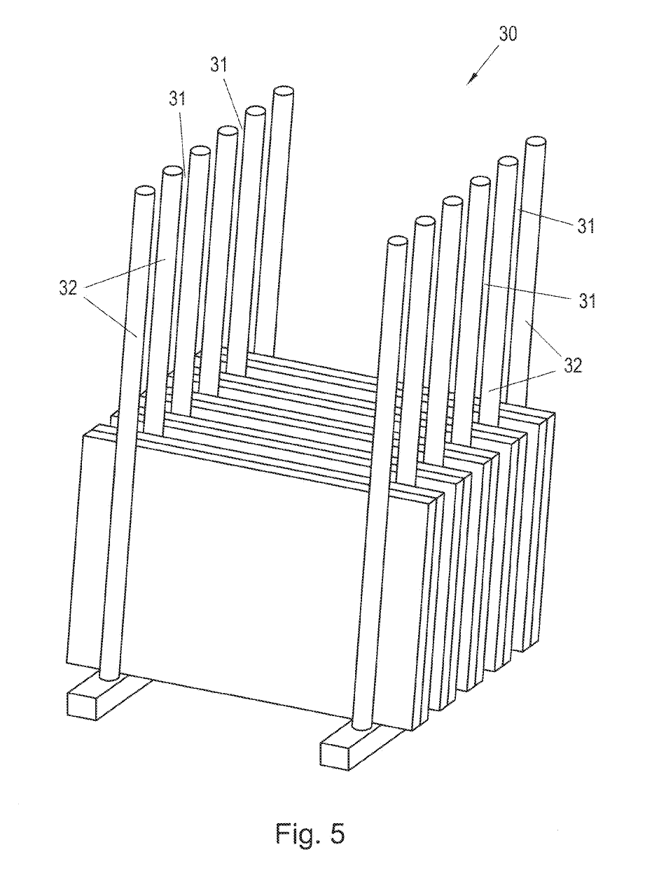

FIG. 5 shows a compartment rack that can be used together with the device according to the invention,

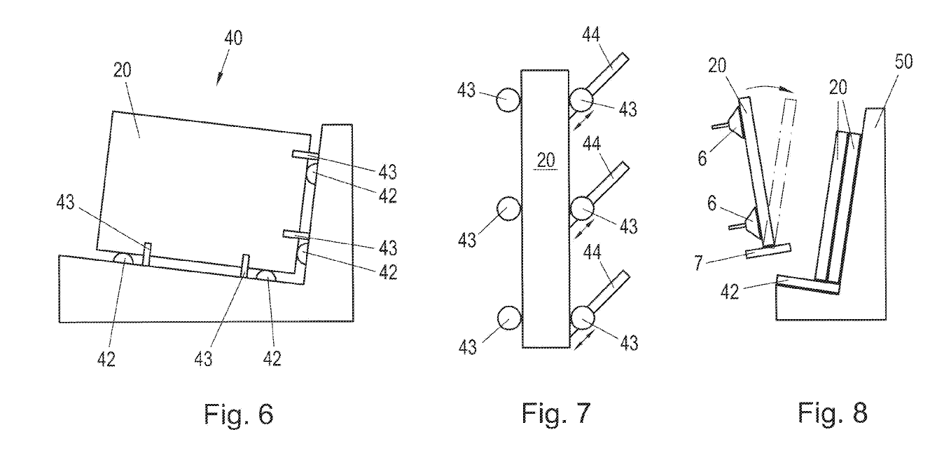

FIGS. 6 and 7 show in two different views a storage support that can be used within the scope of the invention, and

FIG. 8 shows a stack support.

A device 1 according to the invention comprises a suction field 2, which is arranged on an arm 3 that is oriented essentially vertically and that can be run along a guide rail 5 that is oriented horizontally over a slot 4. In the embodiment shown, the suction field 2 comprises multiple suction devices 6, whereby measures are taken to ensure that only the suction devices 6 are supplied with underpressure, which devices are located in the area of a sealed insulating-glass blank 20.

The suction field 2 can also be arranged in a movable manner on a robotic arm, for example a spherical robotic arm or a bendable robotic arm, according to multiple degrees of freedom.

The suction devices 6 of the suction field 2 are made retractable so that suction devices 6 are not adjacent to the edge of the insulating-glass blank 20 when the suction field 2 is wider than the insulating-glass blank 20 (risk of soiling a suction device 6 by sealing compound).

On the lower edge of the suction field 2, support elements 8 comprising support fingers 7 are provided in the embodiment shown, which elements can be pivoted around axes (essentially vertical axes) parallel to the plane of the suction field 2 into their active position that is oriented crosswise to the plane of the suction field 2 and from this active position into a ready position that is oriented parallel to the suction field 2.

As can be seen from FIG. 1, the device 1 according to the invention in the example depicted in the drawings is assigned to the outflow 10 from a sealing station (not shown). The device 1 according to the invention can also be provided before a sealing station 1, however, in order to convey insulating-glass blanks 20 from an assembly station into a sealing station.

In the example that is shown, a chain conveyor 11 with the design known from AT 384 596 B is provided in the outflow 10 from the sealing station below. The upper edge of the insulating-glass blanks 20 is supported by a bar 22 that is equipped with rollers 21 that can rotate freely, which bar can be oriented by adjusting relative to the upper edge of an insulating-glass blank 20. Also, this bar 22 that is equipped with rollers 21 that can rotate freely is known per se from AT 384 596 B.

In FIG. 2, it is shown how an insulating-glass blank 20 (for triple-insulating glass, diagrammatically reproduced in the example) has been filled with sealing compound after its edge seam has been moved to the end of the outflow 10. FIG. 2 also shows that the suction field 2 has been moved into a position in which it can be affixed to the insulating-glass blank 20 by supplying the suction device 6 with underpressure.

As soon as the suction field 2 has been affixed to the insulating-glass blank 20 and holds the insulating-glass blank 20, the suction field 2 is moved to the right (arrow 23) of FIG. 2 and picks up the insulating-glass blank 20 from the outflow 10 from the sealing station.

The suction field 2 can be pivoted (tilted) around an axis that is essentially horizontal and essentially parallel to the plane of the suction field 2. A pivoting movement or tilting can be significant in terms of a turning-over movement if a (sealed) insulating-glass blank 20 is to be tilted from a specific slope against the vertical, e.g., +6°, into another slope against the vertical, e.g., −3°, while it is deposited on a support. In contrast, a tilting may be necessary in terms of an edging movement when an insulating-glass blank 20, which outflows from the sealing station with a horizontal lower edge, is brought into a position in which its lower edge corresponds to the support, as it is shown in FIG. 7.

As FIG. 3 shows, the support fingers 7 are pivoted into their active positions as soon as they are arranged beside the end of the lower conveyor 11 of the outflow 10 from the sealing station because of the movement of the suction field 2 away from the outflow 20. Thus, it is ensured that the glass pane (in the case of two-pane insulating glass) or the panes (in the case of three- or multi-pane insulating glass) of the insulating-glass blank, on which the suction field 2 does not engage, is/are always supported from below, so that no shearing forces, which could bring about a slipping of the packet that consists of glass panes and a spacer, can act on the insulating-glass blank 20.

Consideration is given to designing the arm 3 (or the suction field 2 relative to the arm 3) in addition to the above-mentioned degrees of freedom of movement in a rotatable manner around an essentially vertical axis. This is advantageous since insulating-glass blanks 20 can be introduced (set) in depositing devices after sealing, in which devices they are not parallel to the operating plane.

As soon as a sealed insulating-glass blank 20, as shown in FIG. 4, is picked up by the suction field 2 and is supported from below by support fingers 7, it is moved away from the outflow 10 of the sealing station and moved into a storage area for insulating-glass blanks 20 and deposited there in a compartment rack or on a storage support so that the sealing can harden there.

A storage area for insulating-glass blanks 20 can be formed by at least one compartment rack 30, as is shown diagrammatically in FIG. 5. The compartment rack 30 has compartments 31, which are formed by rods 32, which are free on their upper ends, i.e., not connected to one another, so that the suction field 2 with an insulating-glass blank 20 can be moved from above into a compartment 31. A compartment rack 30 can be designed to be stationary, freely movable on wheels, or transportable on rails. After the insulating-glass blank 20 is deposited in a compartment 31, the support fingers 7 are pivoted into their ready position, and the suction field 2 with support fingers 7 of the device 1 according to the invention can be moved out upward from the compartment 30 of the compartment rack 30.

As an alternative, sealed insulating-glass blanks 20 can be deposited gently onto a storage support 40 by the device 1 according to the invention, as is shown diagrammatically, for example, in FIGS. 6 and 7. A storage support 40 can be designed to be stationary, freely movable on wheels, or transportable on rails. In its areas on which the edges of the sealed insulating-glass blanks 20 rest, the storage support 40 has support elements 42, which are arranged so that the suction field 2 with an insulating-glass blank 20 that is held by it and support fingers 7 pivoted into its active position moves into the storage support 40, and the insulating-glass blank 20 can be supported on the support elements 42 of the storage support 40. As soon as an insulating-glass blank 20 has been set, lateral holding elements 43 that are provided in the storage support 40 are affixed to the insulating-glass blank 20 (on its exterior).

The storage support 40 has a vertical-horizontal L-shaped base rack, which is a conceivable option in addition to the form in FIG. 6 that is tilted from the orthogonal. The holding elements 43 can be at least partially movable and stoppable in various positions so that the holding elements 43 can be used for insulating-glass blanks 20 of various thicknesses. For this purpose, holding elements 43 are arranged in a movable manner on oblique guideways at least on one side. To this end, the holding elements 43 can be designed so that they can be moved in the guideways 44 and are loaded with spring force so that they are affixed to the set insulating-glass blank 20 in order to stabilize it laterally. Not all holding elements 43 have to be movable; it is enough if the holding elements 43 of each second vertical series have this property. As soon as this has taken place, the support fingers 7 can be pivoted into their ready position, and the suction field 2 of the device 1 can be moved away upward from the storage support 40.

Apart from the compartment rack 30 and storage supports 40 of the type shown in FIGS. 5 or 6 and 7, simple stack supports 50, as they are depicted in FIG. 8, can also be used. Also, the stack supports 50 can be designed to be stationary, freely movable on wheels, or transportable on rails. Support elements 42 are provided in the stack support 50. As shown in FIG. 8, when depositing an insulating-glass blank in the stack support 50, the suction field 2 executes a pivoting movement (“tilting movement”) around an axis that is essentially horizontal and parallel to the plane of the suction field 2 (for example, from +6° to −3°.

The pivotability of the suction field 2 around an axis that is essentially horizontal and at least approximately parallel to the plane of the suction field 2 makes it possible to execute a turning-over-tilting (cf. FIG. 8) with the object that is held by the suction field 2 and supported by the support fingers 7, e.g., an insulating-glass blank 20. When the suction field 2 can be rotated around an axis that is essentially perpendicular to its plane, an edging-tilting movement can be executed with the object, during which movement the object, e.g., an insulating-glass blank 20, is rotated around an axis that is normal to it.

In summary, an embodiment of the invention can be described as follows:

For the transport of plate-like objects, such as insulating-glass blanks 20, for example from the outflow 10 from a sealing station into a storage area formed by compartment racks 30 and/or storage supports 40, a device 1 is proposed, which device has a suction field 2 that can be affixed to an insulating-glass blank 20. Support fingers 7 are provided on the lower edge of the suction field 2, which fingers support the insulating-glass blank 20 that is held by the suction field 2 from below, whereby the support fingers 7 can be pivoted into their active positions independently of one another. After the depositing of an insulating-glass blank 20 in a compartment rack 30 or on a storage support 40, the support fingers 7 are pivoted back into their ready position, so that the suction field 2 can be moved away upward from the compartment rack 30 or the storage support 40.

1-14. (canceled)

15. Device (1) for transporting plate-like objects with a suction field (2) and with support elements (8) provided in the area of the lower edge of the suction field (2), which elements can be switched into their and out of their active positions, characterized in that the suction field (2) of the device (1) for transporting insulating-glass blanks is assigned to the outflow (10) from a sealing station, in that the support elements (8), independently of one another, beginning with the support element (8) that is adjacent to the sealing station, can be switched in succession into their active positions resting on the lower edge of an insulating-glass blank (20), as soon as they are arranged beside the end of the lower conveyor of the outflow (10) from the sealing station because of the movement of the suction field (2) away from the outflow from the sealing station.

16. Device according to claim 15, wherein the support elements (8) comprise support fingers (7).

17. Device according to claim 15, wherein the support elements (8), in particular the support fingers (7), can be moved by pivoting from their ready position behind the plane defined by the suction field (2) into their active position, in which they are crosswise to the plane defined by the suction field (2).

18. Device according to claim 15, wherein the support elements (8) can be pivoted around axes that are essentially vertical, parallel to the plane of the suction field (2).

19. Device according to claim 15, wherein the suction field (2) can be adjusted via an arm (3) and a slot (4) on a horizontal rail (5) using a drive.

20. Device according to claim 19, wherein the arm (3), which carries the suction field (2), is held in a vertically adjustable manner in the slot (4).

21. Device according to claim 15, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

22. Device according to claim 19, wherein a drive is assigned to the slot (4) for running along the rail (5).

23. Device according to claim 16, wherein the support elements (8), in particular the support fingers (7), can be moved by pivoting from their ready position behind the plane defined by the suction field (2) into their active position, in which they are crosswise to the plane defined by the suction field (2).

24. Device according to claim 16, wherein the support elements (8) can be pivoted around axes that are essentially vertical, parallel to the plane of the suction field (2).

25. Device according to claim 17, wherein the support elements (8) can be pivoted around axes that are essentially vertical, parallel to the plane of the suction field (2).

26. Device according to claim 16, wherein the suction field (2) can be adjusted via an arm (3) and a slot (4) on a horizontal rail (5) using a drive.

27. Device according to claim 17, wherein the suction field (2) can be adjusted via an arm (3) and a slot (4) on a horizontal rail (5) using a drive.

28. Device according to claim 18, wherein the suction field (2) can be adjusted via an arm (3) and a slot (4) on a horizontal rail (5) using a drive.

29. Device according to claim 16, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

30. Device according to claim 17, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

31. Device according to claim 18, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

32. Device according to claim 19, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

33. Device according to claim 20, wherein the suction field (2) can be tilted around an axis that is essentially horizontal and essentially parallel to the plane of the suction field (2) and/or can be rotated around an essentially vertical axis and/or around an axis that is essentially normal to the plane of the suction field (2).

34. Device according to claim 20, wherein a drive is assigned to the slot (4) for running along the rail (5).
